(19) United States
(12) Patent Application Publication
(10) Pub. No.: US 2008/0048552 A1
(43) Pub. Date: Feb. 28, 2008

(54) Image display device

(76) Inventors: Hiroshi Ito, Chiba (JP); Nobuhiko Hosotani, Mobara (JP); Shigemi Hirasawa, Chiba (JP); Yuuichi Kijima, Chosei (JP); Kenji Kato, Mobara (JP); Takashi Naito, Funabashi (JP); Yuuichi Sawai, Miyazaki (JP)

Correspondence Address: MILBANK, TWEED, HADLEY & MCCLOY, 1 CHASE MANHATTAN PLAZA, NEW YORK, NY, 10005-1413, US

(21) Appl. No.: 11/893,246

(22) Filed: Aug. 15, 2007

(30) Foreign Application Priority Data
Aug. 24, 2006 (JP) 2006-227392

(51) Int. Cl. H01J 63/04

(52) U.S. Cl. 313/496

(57) ABSTRACT

In an image display device which forms an image by allowing electrons from electron sources which are arranged in a matrix array to impinge on phosphors in the inside of a vacuum envelope, the degree of vacuum during an operation of the image display device is improved. A vacuum envelope is formed of a face substrate, a back substrate and a support body which is arranged between and along peripheries of the face substrate and the back substrate using a sealing material. By using frit glass which contains vanadium oxide as a main component for a material of the sealing material, due to a getter action of frit glass which contains vanadium oxide as the main component, after vacuum evacuation, a lifetime of the display device can be prolonged. Further, by using frit glass which contains vanadium oxide as the main component for a material of an adhesive material which bonds the spacers and the face substrate or bonds the spacers and the back glass, the getter action can be further enhanced. Further, by applying frit glasses which contain vanadium oxide as a main component to side surfaces of the spacers or portions of the inside of the display device which do not influence the formation of image by coating, the getter action can be further enhanced.

### BACKGROUND OF THE INVENTION

1. Field of the Invention

The present invention relates to a planar image display device which maintains the inside thereof in a vacuum state and forms an image by making use of electron sources arranged in a matrix array and phosphors formed corresponding to the electron sources, and more particularly to a technique for maintaining the degree of vacuum in the inside of the image display device.

2. Description of the Related Art

A color cathode ray tube has been popularly used conventionally as an excellent display device which exhibits high brightness and high definition. However, along with the realization of high image quality of recent information processing device and television broadcasting, there has been a strong demand for a planar image display device (flat panel display, FPD) which is light-weighted and requires a small space for installation while ensuring the properties such as high brightness and high definition.

As typical examples of such a planar image display device, a liquid crystal display device, a plasma display device or the like has been put into practice. Further, particularly with respect to the planar display device which can realize the high brightness, various planar image display devices such as a self luminous display device which makes use of emission of electrons into vacuum from electron sources (for example, an electron emitting type image display device, a field emitting type image display device) or an organic EL display which is characterized by low power consumption are expected to be put into practice in near future. Among these planar image display devices, with respect to the self-luminous flat panel display, there has been known a display device having the constitution in which electron sources are arranged in a matrix array.

In the self-luminous flat panel display, as cold cathodes, electron sources of a Spindt type, a surface conduction type, a carbon nanotubes type, an MIM (Metal-Insulator-Metal) type which laminates a metal layer, an insulator layer and a metal layer, an MIS (Metal-Insulator-Semiconductor) type which laminates a metal layer, an insulator and a semiconductor layer, a metal-insulator-semiconductor-metal type or the like have been used.

In the planar image display devices, there has been known a display panel which is constituted of a back substrate having the above-mentioned electron sources, a face substrate which includes phosphor layers and anodes which form accelerating electrode for allowing electrons emitted from the electron sources to impinge on the phosphor layers, and a support body which constitutes a sealing frame for sealing an inner space formed by opposing surfaces of both substrates into a predetermined vacuum state. The planer image display device is operated by combining a drive circuit and the display panel.

The image display device having the electron source includes a back substrate which has a large number of first electrodes (for example, cathode electrodes, image signal electrodes) which extend in the first direction and are arranged in parallel in the second direction which intersects the first direction, an insulation film which is formed in a state that the insulation film covers the first electrodes, a large number of second electrodes (for example, gate electrodes, scanning signal electrodes) which extend in the second direction and are arranged in parallel in the first direction over the insulation film, and electron sources which are provided in the vicinity of intersecting portions of the first electrodes and the second electrodes. The back substrate includes a substrate made of an insulating material and the above-mentioned electrodes are formed on the substrate.

In such a constitution, a scanning signal is sequentially applied to the scanning signal electrodes in the above-mentioned first direction. Further, on the substrate, the above-mentioned electron sources are arranged on respective intersecting portions of the scanning signal electrodes and the image signal electrodes, and both electrodes and electron sources are connected with each other by power-supply electrodes for supplying an electric current to the electron sources. The face substrate is arranged to face the back substrate in an opposed manner, wherein phosphor layers of plural colors and a third electrode (an anodic electrode, anode) are formed on an inner surface of the face substrate which faces the back substrate in an opposed manner. The face substrate is made of a light-transmitting material, which is preferably glass. Further, both substrates are sealed by inserting a supporting body which constitutes a sealing frame between stacked inner peripheries of both substrates, and an inner space which is defined by the back substrate, the face substrate and the supporting body is evacuated into vacuum thus constituting the image display device.

The electron sources are positioned at the intersecting portions of the first electrodes and the second electrodes as mentioned above. An emission quantity of electrons from the electron source (including the turning on and off of the emission) is controlled based on a potential difference between the first electrode and the second electrode. The emitted electrons are accelerated due to a high voltage applied to the anode formed on the face substrate and impinge on phosphor layers formed on the face substrate thus exciting the phosphor layers and the light of colors corresponding to light emitting characteristics of the phosphor layers are generated.

Each individual electron source forms a unit pixel in pair with a corresponding phosphor layer. Usually, one pixel (color pixel) is constituted of the unit pixels of three colors consisting of red (R), green (G) and blue (B). Here, in the case of the color pixel, the unit pixel is also referred to as a sub pixel.

In the planner image display device described above, in general, in the inside of a display region which is arranged between the back substrate and the face substrate and is surrounded by the support body, a plurality of distance holding members (hereinafter referred to as spacers) are arranged and fixed thus holding the distance between the above-mentioned both substrates at a given distance in cooperation with the support body. The spacers are formed of a plate-like body which is made of an insulation material such as glass, ceramics or the like, in general. Usually, the spacers are arranged every plurality of pixels at positions which do not impede an operation of pixels.

Further, the support body which constitutes the sealing frame is interposed between the back substrate and the face substrate and is fixed to inner peripheries of the back substrate and the face substrate using a sealing material such as frit glass, and the fixing portions are hermetically sealed thus forming sealing regions. The degree of vacuum in the inside of a display region defined by both substrates and the support body is set to 10⁻³ to 10⁻⁵ Pa, for example.

First electrode lead terminals which are connected to the first electrodes formed on the back substrate and second electrode lead terminals which are connected to the second electrodes formed on the back substrate penetrate the sealing regions formed between the support body and both substrates. Usually, the support body which constitutes the sealing frame is fixedly secured to the back substrate and the face substrate using the sealing material such as frit glass or the like. The first electrode lead terminals and the second electrode lead terminals are pulled out through the sealing region which constitutes a hermetic sealing portion formed between the sealing frame and the back substrate.

Although the inside of the display device is evacuated into a vacuum, when an exhaust pipe is subject to chipping-off after such evacuation, gasses are gradually discharged from a structural body which constitutes the inside of the display device and hence, the degree of vacuum is deteriorated. To cope with the deterioration of the degree of vacuum, there has been known the structure which imparts a gas absorption function (hereinafter, referred to as a getter action) to Ba by scattering a Ba getter used in a cathode ray tube or the like. However, in the above-mentioned planar image display device, different from the cathode ray tube, the display device cannot acquire a sufficient scattering area of Ba. When the scattering area of Ba is not sufficient, it is impossible to expect the sufficient getter action attributed to Ba. Patent document 1 discloses a technique which, in place of the getter action attributed to Ba, forms a metal back formed on a phosphor screen using Ti, Zr or alloy thereof and makes such metal perform a getter action.

[Patent document 1] JP-A-9-82245

### SUMMARY OF THE INVENTION

### Problems to be Solved by the Invention

In the above-mentioned planar display device, electrons from the electron sources are accelerated with an anode voltage and impinge on phosphors to make the phosphors emit light. Here, the electron beams are required to pass through the metal back formed on the phosphors. The anode voltage of the planar display device is relatively low compared to the anode voltage of a cathode ray tube, that is, 8 kV to 10 kV. The smaller the acceleration voltage is, the smaller the transmissivity of electrons which pass through the metal back becomes. Further, provided that a film thickness of the metal back is equal, the smaller amass of the metal back is, the easier the transmission of the electrons becomes. Accordingly, an Al film is preferably used as the metal back.

As in the case of the technique disclosed in the above-mentioned patent document 1, when Ti, Zr or alloy thereof is used as a material of the metal back, the metal back transmissivity of electrons is decreased thus giving rise to a drawback that sufficient display brightness cannot be acquired.

Accordingly, it is an object of the present invention to ensure a getter action necessary for a display device without sacrificing brightness of a display device.

### Means for Solving the Problems

The present invention uses frit glass having a getter action which contains vanadium oxide as a main component for a sealing material between the structures which constitute an envelope, an adhesive material which adheres spacers to the inside of the display device or the like. Frit glass acquires the getter action after the inside of the display device is evacuated and hence, it is possible to prevent the deterioration of the degree of vacuum of the display device during an operation for a long time. Further, by applying vanadium oxide to the structures inside the display device, it is possible to further enhance the getter action. Vanadium oxide is classified into insulating vanadium oxide and conductive vanadium oxide and hence, vanadium oxide may be selectively used depending on the structures. The present invention adopts the following constitutions.

(1) The present invention is directed to a display device in which an envelope which holds a vacuum therein is formed of a face substrate, a back substrate and a support body which is arranged between peripheries of the face substrate and the back substrate, electron sources are arranged on the back substrate in a matrix array, phosphors are arranged on the face substrate at portions of the face substrate corresponding to the electron sources, and an effective screen part is formed of the electron sources arranged in a matrix array and the phosphors, wherein a sealing material between the face substrate and the support body and between the back substrate and the support body is made of frit glass which contains vanadium oxide as a main component.

(2) In the display device having the constitution described in (1), the frit glass which forms the sealing material possesses an insulating property.

(3) In the display device having the constitution described in (1), the frit glass which forms the sealing material contains 30% to 40% of vanadium oxide in V₂O₅ conversion and, at the same time, contains 25% to 35% of tellurium oxide in TeO₂ conversion.

(4) The present invention is directed to a display device in which an envelope which holds a vacuum therein is formed of a face substrate, a back substrate and a support body which is arranged between peripheries of the face substrate and the back substrate, electron sources are arranged on the back substrate in a matrix array, phosphors are arranged on the face substrate at portions of the face substrate corresponding to the electron sources, and an effective screen part is formed of the electron sources arranged in a matrix array and the phosphors, wherein a peripheral portion is formed between an end portion of the effective screen part and the support body, spacers which hold a distance between the face substrate and the back substrate are arranged within the effective screen part, the spaces are mounted on the face substrate and the back substrate using an adhesive material, and the adhesive material is frit glass which contains vanadium oxide as a main component.

(5) In the display device having the constitution described in (4), the frit glass which contains vanadium oxide as the main component possesses a conductivity.

(6) In the display device having the constitution described in (4), the frit glass which contains vanadium oxide as the main component contains 50% to 65% of vanadium oxide in V₂O₅ conversion and, at the same time, contains 20% to 30% of phosphorus oxide in P₂O₅ conversion.

(7) In the display device having the constitution described in (4), the frit glass which contains vanadium oxide as the main component is formed on a side surface of the spacer.

(8) The present invention is directed to a display device in which an envelope which holds a vacuum therein is formed of a face substrate, a back substrate and a support body which is arranged between peripheries of the face substrate and the back substrate, a plurality of video signal lines which extend in a first direction and are arranged in parallel in a second direction, a plurality of scanning lines which extend in the second direction and are arranged in parallel in the first direction, and electron sources which are arranged in the vicinity of intersecting portions of the scanning lines and the video signal lines are formed on the back substrate, phosphors are arranged on the face substrate at portions of the face substrate corresponding to the electron sources, a black matrix is formed around the phosphor, an effective screen part is formed of the electron sources and the phosphors, a peripheral portion is formed between an end portion of the effective screen part and the support body, and spacers which hold a distance between the face substrate and the back substrate are arranged within the effective screen part, wherein frit glass which contains vanadium oxide as a main component is formed on the scanning lines.

(9) The present invention is directed to a display device in which an envelope which holds a vacuum therein is formed of a face substrate, a back substrate and a support body which is arranged between peripheries of the face substrate and the back substrate, a plurality of video signal lines which extend in a first direction and are arranged in parallel in a second direction, a plurality of scanning lines which extend in the second direction and are arranged in parallel in the first direction, and electron sources which are arranged in the vicinity of intersecting portions of the scanning lines and the video signal lines are formed on the back substrate, phosphors are arranged on the face substrate at portions of the face substrate corresponding to the electron sources, a black matrix is formed around the phosphor, an effective screen part is formed of the electron sources and the phosphors, a peripheral portion is formed between an end portion of the effective screen part and the support body, and spacers which hold a distance between the face substrate and the back substrate are arranged within the effective screen part, wherein frit glass which contains vanadium oxide as a main component is formed on the peripheral portion of the face substrate.

(10) In the display device having the constitution described in (9), the frit glass which contains vanadium oxide as the main component and is formed on the peripheral portion of the face substrate has a resistivity equal to or more than 10⁹ Ω·cm.

(11) The present invention is directed to a display device in which an envelope which holds a vacuum therein is formed of a face substrate, a back substrate and a support body which is arranged between peripheries of the face substrate and the back substrate, a plurality of video signal lines which extend in a first direction and are arranged in parallel in a second direction, a plurality of scanning lines which extend in the second direction and are arranged in parallel in the first direction, and electron sources which are arranged in the vicinity of intersecting portions of the scanning lines and the video signal lines are formed on the back substrate, phosphors are arranged on the face substrate at portions of the face substrate corresponding to the electron sources, a black matrix is formed around the phosphor, an effective screen part is formed of the electron sources and the phosphors, a peripheral portion is formed between an end portion of the effective screen part and the support body, and spacers which hold a distance between the face substrate and the back substrate are arranged within the effective screen part, wherein frit glass which contains vanadium oxide as a main component is formed on the peripheral portion of the back substrate.

(12) The present invention is directed to a display device in which an envelope which holds a vacuum therein is formed of a face substrate, a back substrate and a support body which is arranged between peripheries of the face substrate and the back substrate, a plurality of video signal lines which extend in a first direction and are arranged in parallel in a second direction, a plurality of scanning lines which extend in the second direction and are arranged in parallel in the first direction, and electron sources which are arranged in the vicinity of intersecting portions of the scanning lines and the video signal lines are formed on the back substrate, phosphors are arranged on the face substrate at portions of the face substrate corresponding to the electron sources, a black matrix is formed around the phosphor, an effective screen part is formed of the electron sources and the phosphors, a peripheral portion is formed between an end portion of the effective screen part and the support body, and spacers which hold a distance between the face substrate and the back substrate are arranged within the effective screen part, wherein frit glass which contains vanadium oxide as a main component is formed on an inner surface of the support body.

According to the means described in (1) to (6), frit glass which is used as the sealing material of the envelope including the face substrate, the back substrate and the support body has a getter action and hence, it is possible to prevent a phenomenon that the degree of vacuum in the inside of the display device after the evacuation of the inside of the display device is deteriorated thus prolonging a lifetime of the display device. Further, according to the present invention, it is possible to achieve the above-mentioned object by merely changing a material of the sealing material, without increasing the number of the conventional parts and processing. Thus, it is possible to obtain an advantageous effect that the lifetime of the display device can be prolonged without incurring the increase of a cost.

According to the means described in (7) to (12), the further excellent getter action can be acquired and hence, it is possible to surely prolong the lifetime of the display device. Further, the present invention requires only applying frit glass which contains vanadium oxide as the main component to the inner structure, and does not require any additional processes such as baking process or activating process after applying frit glass and hence, it is possible to prolong the lifetime of the display device without incurring the large increase of a cost. Further, according to the means described (1), the voltage resistance characteristic can also be enhanced together with the prolongation of lifetime of the display device.

### BRIEF DESCRIPTION OF THE DRAWINGS

FIG. 1A and FIG. 1B are views for explaining one embodiment of an image display device according to the present invention, wherein FIG. 1A is a plan view as viewed from a face substrate side and FIG. 1B is a side view of FIG. 1A;

FIG. 2 is a schematic plan view of a back substrate in a state that the face substrate shown in FIG. 1A is removed;

FIG. 3 is a schematic cross-sectional view taken along a line A-A in FIG. 1A;

FIG. 4 is a schematic cross-sectional view taken along a line B-B in FIG. 2;

FIG. 5 is a schematic cross-sectional view taken along a line C-C in FIG. 1A;

FIG. 6 is a graph showing a change of the degree of vacuum, showing an advantageous effect of the present invention;

FIG. 7 is a plan view of a back substrate showing a second embodiment of the present invention;

FIG. 8 is a schematic cross-sectional view taken along a line A-A in FIG. 7;

FIG. 9 is a schematic cross-sectional view taken along a line B-B in FIG. 7;

FIG. 10 is a schematic cross-sectional view showing an inner side of a face substrate of the second embodiment of the present invention;

FIG. 11A and FIG. 11B are views showing the constitution of a phosphor screen of the second embodiment of the present invention, wherein FIG. 11A is a schematic plan view of the phosphor screen with a metal back being removed, and FIG. 11B is a schematic cross-sectional view of the phosphor screen to which the present invention is applied;

FIG. 12 is a plan view of a back substrate showing a third embodiment of the present invention; and

FIG. 13 is a schematic cross-sectional view of a getter chamber of the third embodiment of the present invention.

### DESCRIPTION OF THE PREFERRED EMBODIMENTS

The present invention uses vanadium (V)-based frit glass disclosed hereinafter (hereinafter, referred to as V frit) in place of conventional lead-based frit glass for sealing a face substrate and a back substrate and a support body which surrounds peripheries of the face substrate and the back substrate or for adhering the face substrate and the back substrate and spacers, thus imparting a getter action to V frit as well as sealing and adhering actions. V frit is classified into insulating V frit and conductive V frit. Insulating V frit consists of, for example, 30% to 40% of V₂O₅, 5% of ZnO, 15% of BaO, 5% of WO₃, 25% to 35% of TeO₂ and balance. On the other hand, conductive V frit consists of, for example, 50% to 65% of V₂O₅, 20% to 30% of P₂O₅, 5% of Sb₂O₃, and BaO as balance. The above-mentioned components are of V frit after sintered. At a point of time that V frit is applied, V frit is in a paste form and the above-mentioned components are dispersed on vehicles. The vehicles are scattered and dissipated when V frit is baked after coating.

It is necessary to selectively use insulating V frit and conductive V frit depending on portions of the display device where V frit is used.

### Embodiment 1

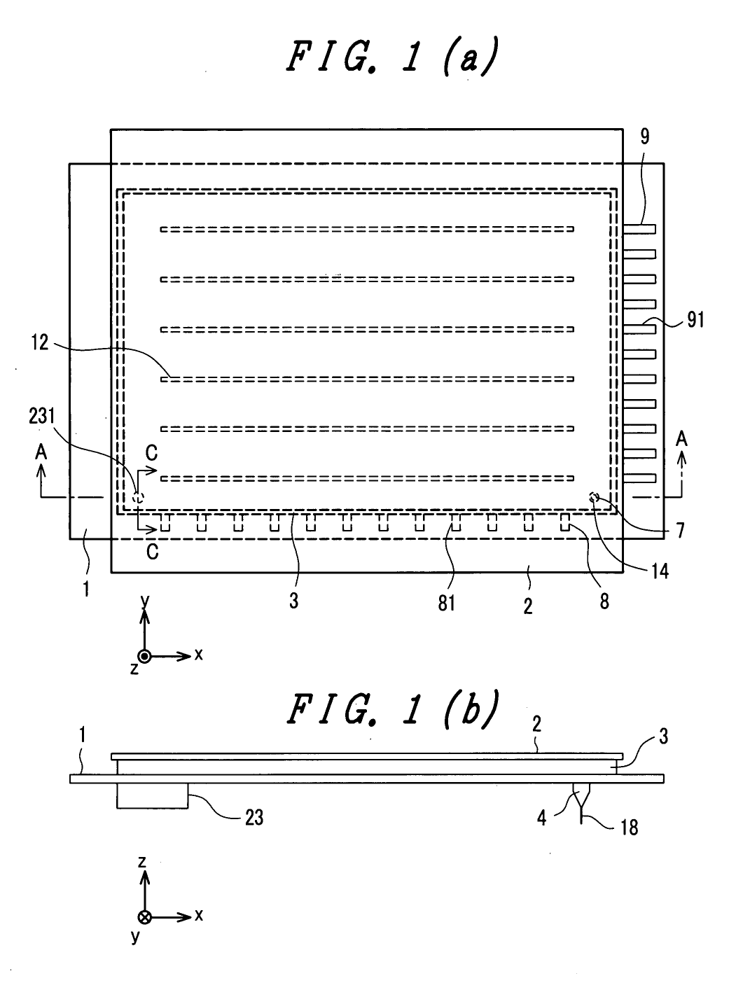

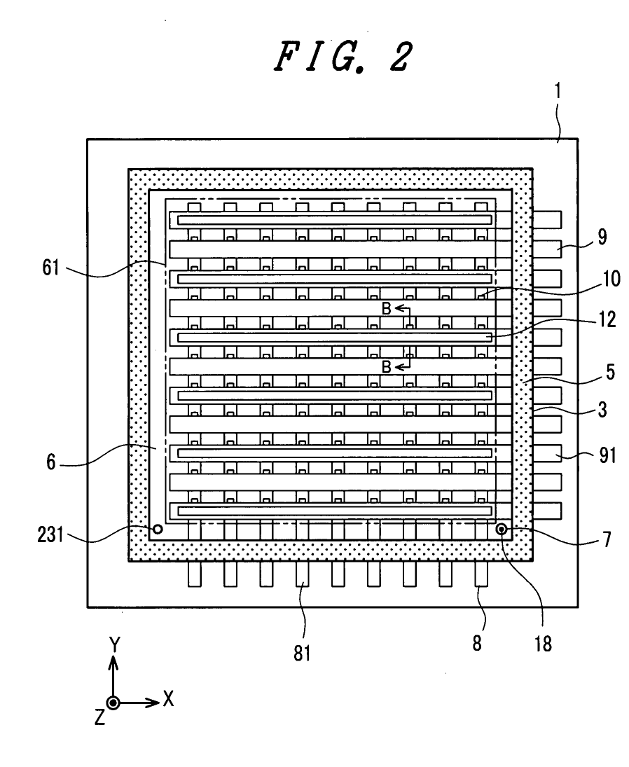

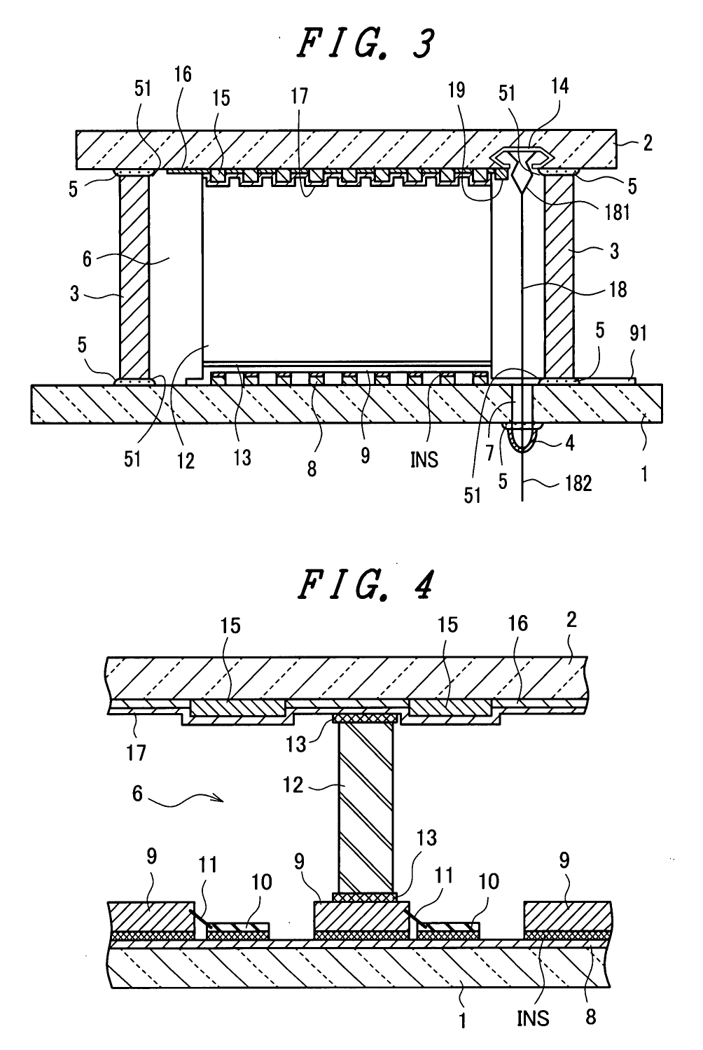

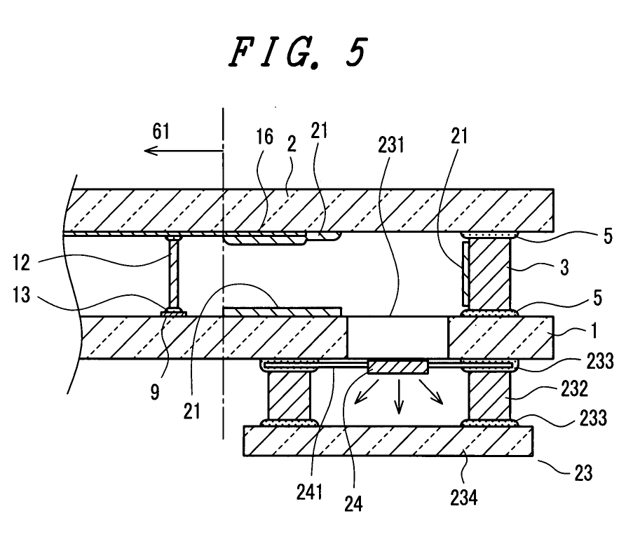

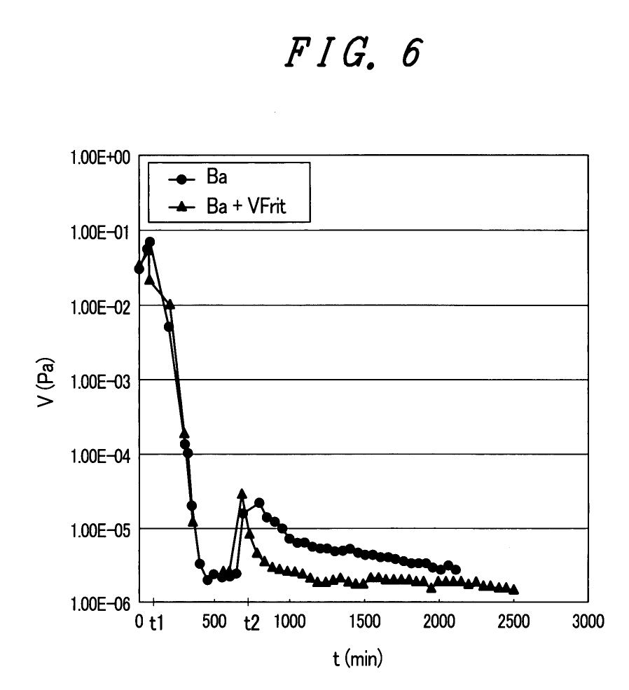

FIG. 1 to FIG. 5 are views for explaining one embodiment of an image display device according to the present invention. FIG. 1A is a plan view as viewed from a face substrate side, FIG. 1B is a side view of FIG. 1A, FIG. 2 is a schematic plan view of a back substrate in a state that the face substrate in FIG. 1A is removed, FIG. 3 is a schematic cross-sectional view taken along a line A-A in FIG. 1A, FIG. 4 is a schematic cross-sectional view taken along a line B-B in FIG. 2, and FIG. 5 is a cross-sectional view taken along a line C-C in FIG. 1A and shows the structure of a getter chamber.

In FIG. 1A to FIG. 5, numeral 1 indicates a back substrate numeral 2 indicates a face substrate, and the both substrates 1, 2 are formed of a glass plate having a thickness of several mm, for example, approximately 3 mm. Numeral 3 indicates a support body, and the support body 3 is formed of, for example, a glass plate or a frit glass sintered body having a thickness of several mm, for example, approximately 3 mm. Numeral 4 indicates an exhaust pipe, and the exhaust pipe 4 is fixedly mounted on the back substrate 1. The support body 3 is interposed between both substrates 1, 2 in a state that the support body 3 surrounds peripheral portions of the substrates 1, 2 and the both substrates 1, 2 are hermetically sealed to the support body 3 using a sealing material 5 such as frit glass. The substrates 1, 2 are arranged coaxially in the overlapping direction (Z direction).

In the present invention, insulating V frit is used as the sealing material 5. As shown in FIG. 3, a projecting portion 51 is formed in an inner side of the sealing material 5. When V frit is used as the sealing material 5, V frit exhibits a getter action after being baked and exhibits a getter action vitrified. The portion of the projecting portion 51 of the sealing material 5 absorbs residual gases in the inside of the display body thus preventing the deterioration of the degree of vacuum in the inside of the display device. The projecting portion 51 of the sealing material 5 extends over the whole circumferences of upper and lower portions of the inside of the display device and hence, the whole area of the projecting portion 51 is considerably increased whereby it is possible to acquire a desired advantageous effect as a getter. The sealing material 5 is provided for electrically insulating the display device and the outside of the display device and hence, insulating V frit is used as the sealing material 5.

The space surrounded by the support body 3, both substrates 1, 2 and the sealing material 5 is evacuated through the above-mentioned exhaust pipe 4 thus holding the degree of vacuum of, for example, 10⁻³ to 10⁻⁵ Pa to form a display region 6. The whole display region 6 does not form an effective screen, and a portion of the display region 6 inside an imaginary line indicated by numeral 61 shown in FIG. 2 forms the effective screen on which an image is actually displayed. Further, the exhaust pipe 4 is substantially coaxially communicated with a through hole 7 which is formed in the back substrate 1 in a penetrating manner, and is mounted on an outer surface of the back substrate 1 as mentioned previously. After completing the evacuation, the exhaust pipe 4 is sealed.

Numeral 8 indicates video signal electrodes and these video signal electrodes 8 extend in one direction (Y direction) and are arranged in parallel in another direction (X direction) on an inner surface of the back substrate 1. These video signal electrodes 8 include video signal electrode lead terminals 81 at end portions thereof. Distal end portions of the terminals hermetically penetrate a hermetically sealed portion between the supporting body 3 and the back substrate 1 and extend to an end portion of the back substrate 1.

Numeral 9 indicates scanning signal electrodes. The scanning signal electrodes 9 extend over the video signal electrodes 8 in the above-mentioned another direction (X direction) in which the video signal electrodes 8 intersect and are arranged in parallel in the above-mentioned one direction (Y direction). These scanning signal electrodes 9 include scanning signal electrode lead terminals 91 at end portions thereof. Distal end portions of the terminals hermetically penetrate a hermetically sealed portion between the above-mentioned supporting body 3 and the back substrate 1 and extend to an end portion of the back substrate 1.

Further, the video signal electrodes 8, the scanning signal electrodes 9 and the through holes 7 are arranged in a spaced apart manner at intervals of at least 3 mm or more. When the intervals become smaller than 3 mm, there exists a possibility that sizes of the respective electrodes may be changed.

Numeral 10 indicates electron sources and the electron sources 10 are formed in the vicinity of respective intersecting portions of the scanning signal electrodes 9 and the video signal electrodes 8. The electron sources 10 are connected with the scanning signal electrodes 9 via connection electrodes 11. Further, an interlayer insulation film INS is arranged between the video signal electrodes 8 and the scanning signal electrodes 9. Here, the video signal electrodes 8 are formed of an aluminum (Al)/neodymium (Nd) film, for example, while the scanning signal electrodes 9 are formed of an iridium (Ir)/platinum (Pt)/gold (Au) film or the like, for example.

Next, numeral 12 indicates spacers. The spacers 12 are made of a ceramic material and are shaped in a rectangular thin plate shape. In this embodiment, the spacers 12 are arranged upright above the scanning signal electrodes 9 every other line, and are fixed to both substrates 1, 2 using an adhesive material 13. The spacers 12 are usually arranged at positions which do not impede operations of pixels for every plurality of respective pixels.

Sizes of the spacers 12 are set based on sizes of substrates, a height of the support body 3, materials of the substrates, an arrangement interval of the spacers 12, a material of spacers and the like. However, in general, the height of the spacers 12 is approximately equal to a height of the support body 3. A thickness of the spacers 12 is set to a value which falls within a range from several 10 μm to several mm, while a length of the spacers 12 is set to a value which falls within a range from approximately 20 mm to 200 mm. Preferably, a practical value of the length of the spacers 12 is approximately 80 mm to 120 mm. Further, the spacers 12 possess a resistance value of approximately 10⁸ to 10⁹ Ω·cm.

Next, numeral 14 indicates a cup-shaped anode terminal, and the anode terminal 14 is made of chromium alloy or the like, for example, and is arranged at a position of an inner surface of the face substrate 2 on a back-substrate 1 side described later. That is, when both substrates 1, 2 coaxially overlap each other in the Z-axis direction, the anode terminal 14 is arranged within the display region 6 and is embedded in the face substrate 2 coaxially with the exhaust pipe 4 arranged at a position close to the support body 3 which does not obstruct the normal display. As a method for embedding the anode terminal 14, treatment such as glass wrapping may be applied to a portion of the anode terminal 14 on a close end surface side of the anode terminal 14 by coating and, thereafter, a portion of the anode terminal 14 on an opening end side may be exposed on an inner surface on the back substrate 1 side. The embedding of the anode terminal 14 is performed at a point of time that the anode terminal 14 is still in a glass plate form, and pretreatment such as cleaning is performed after embedding and, thereafter, the anode terminal 14 is put into predetermined manufacturing steps.

Further, within the same surface of the face substrate 2 on which the anode terminal 14 is arranged, phosphor layers 15 for red, green and blue are arranged in a state that the phosphor layers 15 are defined by light blocking BM (black matrix) films 16 and, further, a metal back 17 which is formed of a metal thin film using a vapor deposition method is formed to cover the BM films 16, for example, and a phosphor screen is formed of the BM films 16 and the metal back 17. The metal back 17 is formed of an aluminum (Al) film.

Next, numeral 18 indicates an anode lead line, and the anode lead line 18 has one end side 181 thereof detachably connected to the anode terminal 14, and has another end side 182 thereof hermetically sealed with the exhaust pipe 4 and pulled out to the outside after extended to the back substrate 1 side substantially parallel to the support body 3 and inserted into the through hole 7. The anode lead line 18 is configured to have the spring structure in which one end side 181 is deformed by pushing, is inserted into the inside of the cup-shaped anode terminal 14, and is expanded and resiliently brought into contact with the anode terminal 14 by releasing the pushing thus assuring a contact thereof with the anode terminal 14. This spring structure is required to possess property which does not damage the spring property of the anode lead line 18 even when heat treatment of approximately 450° C., for example, is applied to the anode lead line 18. Further, the other end side 182 has the linear structure made of a material substantially equal to a material of the exhaust pipe 4 having a thermal expansion coefficient of a Dumet wire, for example. The other end side 182 is hermetically sealed simultaneously with chipping off of the exhaust pipe 4 after being inserted into the through hole 7.

Next, numeral 19 indicates a conductive thick film for connection, and the conductive thick film 19 is applied between the BM (black matrix) film 16 of the phosphor screen and the anode terminal 14 and between the metal back 17 and the anode terminal 14, and the conductive thick film 19 electrically connects the anode terminal 14 and the BM film 16 and the metal back 17. As the conductive thick film 19, a graphite paste which contains graphite as a main component is used, for example. A thickness of the conductive thick film 19 is set to several μm to 20 several μm, and is set to a thickness which can ensure the reliability of the connection. The detailed explanation is described later.

Further, with respect to phosphor materials of these phosphor layers 15, for example, Y₂O₂S:Eu(P22-R) may be used as the red phosphor, ZnS:Cu,Al (P22-G) may be used as the green phosphor, and ZnS:Ag,Cl(P22-B) may be used as the blue phosphor. With such phosphor screen constitution, electrons radiated from the above-mentioned electron source 10 are accelerated and impinge on the phosphor layers 15 which constitute the corresponding pixels. Accordingly, the phosphor layer 15 emits light of a predetermined color and the light is mixed with an emitted light of color of the phosphor of another pixel thus constituting the color pixel of predetermined color. Further, although the metal back 17 is shown to be formed in a planar shape, the metal back 17 may be formed in a stripe shape by dividing the metal back 17 for every pixel row in the direction which intersects the scanning signal electrodes 9.

A getter-use through hole 231 is formed in a left lower side of the display screen in FIG. 1A and FIG. 2. As shown in FIG. 1B, a getter chamber 23 is formed in a back side of the back substrate 1. FIG. 5 is a cross-sectional view taken along a line C-C in FIG. 1A, and shows the structure of the getter chamber 23. A getter 24 shown in FIG. 5 is a barium (Ba) getter which constitutes a scattering getter. When Ba is scattered and adheres to the electron sources or the like, a work function on a surfaces of the electron sources or the like is changed and hence, the stable electron emission cannot be acquired. Accordingly, the getter chamber 23 is formed at a position away from the electron sources and Ba is scattered in the getter chamber 23. The formation of the getter chamber 23 is also for increasing a scattering area of barium. That is, since the distance between the face substrate 2 and the back substrate 1 is only approximately 3 mm, only with the use of the space defined by the face substrate 2 and the back substrate 1, it is not possible to ensure the sufficient scattering area of Ba.

A support body 232 for supporting the getter chamber 23 is hermetically sealed with a back side of the back substrate 1 and a getter chamber cover 234 using a getter-chamber sealing material 233. When the getter-chamber support body 232 and the back side of the back substrate 1 are sealed to each other, a getter holding body 241 is sealed simultaneously and the Ba getter 24 is held at a position in the vicinity of a getter through hole. After the evacuation of the display device is completed and the exhaust pipe 4 is subjected to chipping-off, the getter 24 is subjected to high-frequency heating to scatter Ba. Here, by scattering Ba in directions indicated by arrows in the drawing, it is possible to fully utilize a wall of the getter chamber 23 as a getter.

Although the getter action of Ba is excellent, even with the above-mentioned provision, due to the limitation on the scattering area of the planar display device, it is difficult to acquire a sufficient getter effect. In this embodiment, insulating V frit 21 is used as the sealing material 5 between the support body 3 and the face substrate 2 as well as between the support body 3 and the back substrate 1. Accordingly, the getter action of insulating V frit 21 is utilized to complement the getter action of the Ba getter. The sealing material 5 is required to electrically insulate the display device and the outside of the display device from each other and hence, V frit used as the sealing material 5 is formed of insulating V frit 21.

A paste of insulating V frit 21 is applied to the face substrate 2 and the back substrate 1 by coating using a dispenser or a printing method. Insulating V frit 21 may be applied to the back substrate 1, the face substrate 2 and the support body 3. After the face substrate 2 and the back substrate 1 combined with the support body 3 by way of insulating V frit 21, the combined structure is put into a frit baking furnace to vitrify insulating V frit 21. Insulating V frit 21 is melted once from a paste state and, thereafter, is vitrified. A baking condition necessary for vitrifying insulating V frit 21 is, for example, 430° C. and 30 minutes. When V frit is melted, V frit flows and hence, projecting portions 51 shown in FIG. 3 are formed. V frit is melted, is vitrified and, thereafter, is solidified in the inside of the frit baking furnace. The vitrified V frit acquires the getter action after the display device is evacuated into a vacuum and performing chipping-off. Although a portion of V frit which contributes to the getter action in the inside of the display device is the projecting portion 51 projecting into the inside of the display device, the projecting portion 51 extends over the whole circumference on the face substrate 2 side and the back substrate 1 side and hence, a total area for the getter action becomes considerably large.

To impart the getter action to V frit, it is necessary to activate V frit after baking. After baking V frit, the display device is evacuated into a vacuum. In performing the vacuum evacuation, f or degassing gasses from a structural body, baking is performed at a temperature of 370° C. for about 2 hours. Although gasses are also degassed from V frit in this case, V frit is activated at the temperature of 370° C. simultaneously. Accordingly, a process for activating V frit as the getter is not particularly necessary.

FIG. 6 shows a comparison of a change of the degree of vacuum between a case in which conventional lead-based frit is used as the sealing material 5 and a case in which V frit is used as these align material 5 as in the case of this embodiment. In both cases, a Ba getter is used. In FIG. 6, the change of the degree of vacuum is expressed as Pa on an axis of ordinates, and time (minute) is taken on an axis of abscissas. In FIG. 6, after a lapse of approximately 100 minutes from starting of the measurement of the degree of vacuum, that is, at a point of time t1, the degree of vacuum is deteriorated. This is because the degree of vacuum is temporarily deteriorated when an exhaust pipe is subjected to chipping-off. Thereafter, the degree of vacuum is increased by scattering Ba from the Ba getter. Then, to confirm advantageous effects of the present invention, after a lapse of 700 minutes from starting of the measurement of the degree of vacuum, that is, at a point of time t2, the display device is heated to a temperature of 200° C. so as to forcibly discharge gasses from the structural body inside the display device and, thereafter, the change of the degree of vacuum is measured, and the advantageous effects of the getter action are compared between two cases. As can be clearly understood from FIG. 6, after heating the display device, the case in which V frit according to the present invention is used enhances the degree of vacuum more and hence, the advantageous effects of the present invention are confirmed.

### Embodiment 2

The embodiment 1 discloses the example in which insulating V frit 21 is used as a sealing material 5 and, at the same time, a getter action is imparted to insulating V frit 21. In using V frit as the getter material, in addition to the use of V frit as the sealing material 5, V frit may be arranged at various positions in the inside of the display device. Here, V frit is classified into insulating V frit and conductive V frit, it is necessary to selectively use insulating V frit and conductive V frit depending on positions where V frit is used. An embodiment 2 shows examples in which V frit is arranged at various positions of the display device.

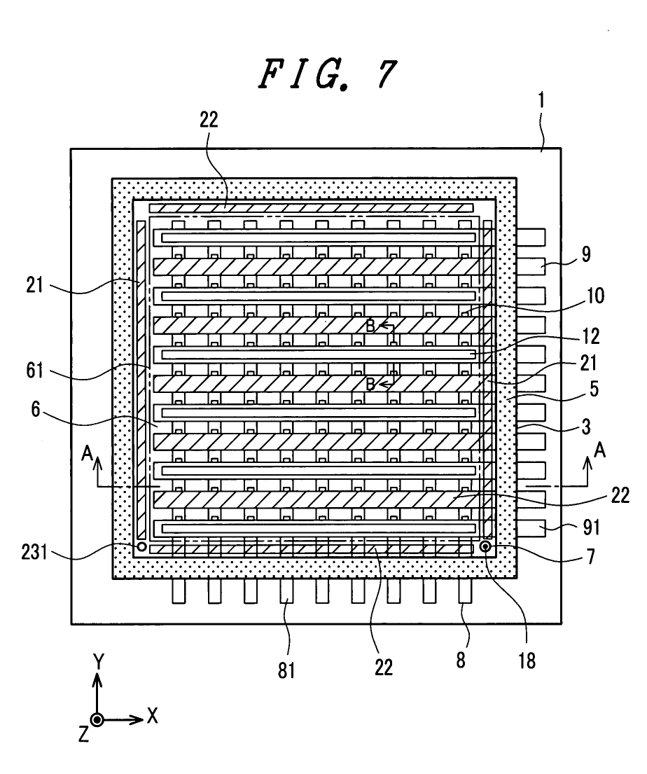

FIG. 7 to FIG. 11B are views for explaining a second embodiment of the image display device of the present invention.

FIG. 7 is a plan view of a back substrate 1 of the embodiment 2. In FIG. 7, V frit is applied to the outside of an effective surface of the back substrate 1 by coating. V frit may be applied by coating using a dispenser or by printing. In the same manner as the embodiment 1, first of all, signal lines 8 are formed, an interlayer insulation film INS is formed on the signal lines 8, and scanning lines 9 are formed on the interlayer insulation film INS. Accordingly, the scanning lines 9 are arranged on an uppermost portion of the image display device. In a display device to which the present invention is applied, an image is formed by making phosphors 15 emit lights using electron beams. Further, a high voltage of 8 kV to 10 kV is applied to anodes. Accordingly, when an internal structural body is charged with electricity, a spark is generated. To prevent such a spark, a surface of the structural body is formed of a conductor as much as possible and a fixed potential is applied to the surface. In this context, V frit applied to the outside of the effective surface by coating in FIG. 7 is preferably conductive. However, since the scanning lines 9 are arranged on the surface of the display device, an insulating V frit 21 is used when V frit is applied astride the scanning lines 9. On the other hand, since the signal lines 8 are covered with an interlayer insulation film and hence, V frit applied astride the signal lines 8 may be conductive. In this case, a fixed potential is preferably applied to conductive V frit 22 from dummy terminals or the like. Accordingly, conductive V frit 22 is used as V frit which is formed in the direction orthogonal to the signal lines 8, while insulating V frit 21 is used as V frit formed in the direction orthogonal to the scanning lines 9.

Conductive V frit 22 is applied to the scanning lines 9 by coating. While a pitch of the scanning lines 9 is 500 μm, a width of the scanning lines 9 is 300 μm. The scanning line width is set to such a large value for preventing a voltage drop of a scanning signal. In this manner, applying the getter material to the scanning lines 9 by coating is extremely advantageous for increasing an area of a getter acting region. As V frit applied to the scanning lines 9 by coating, conductive V frit 22 is properly used from a viewpoint of preventing a charge. Assuming that the positional relationship between the scanning lines 9 and the signal lines 8 is reversed so that the scanning lines 9 form a lower layer and the signal lines 8 form an upper layer with the interlayer insulation film therebetween, it is needless to say that the use positions of insulating V frit 21 and conductive V frit 22 become opposite to each other.

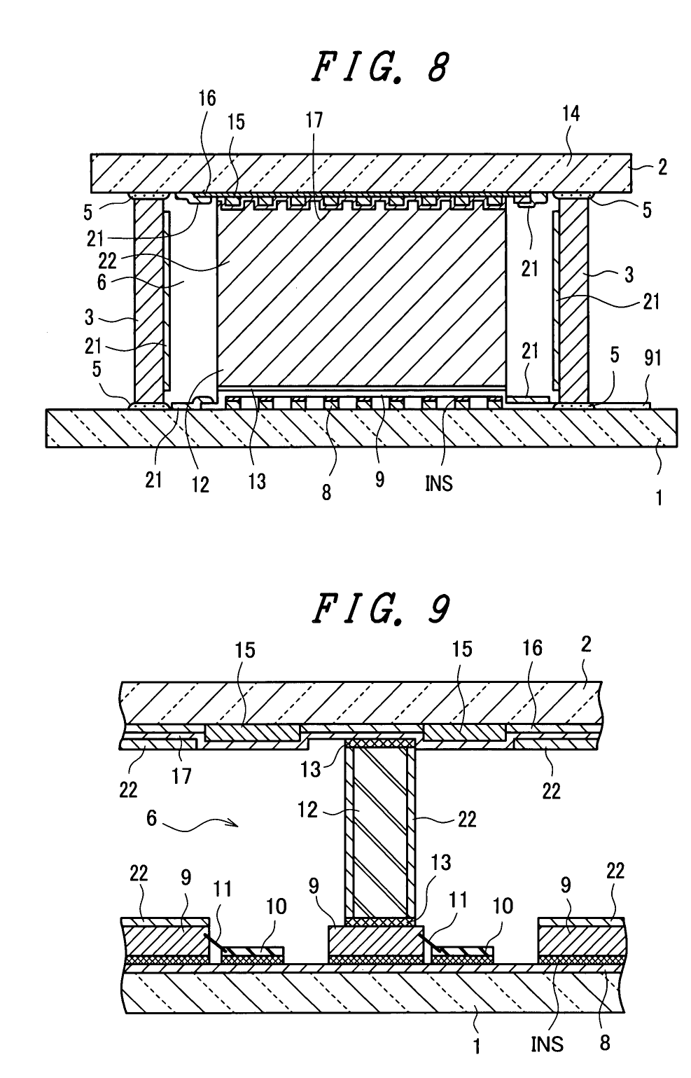

Spacers 12 are formed on some scanning lines 9. The spacers 12 are fixed to the face substrate 2 and the back substrate 1 using an adhesive material 13. Slight conductivity is imparted to the spacers 12 for preventing the spacers 12 from being charged with electricity. By using conductive V frit 22 as the adhesive material 13 of the spacers 12, it is possible to impart a getter effect to the adhesive material 13. Further, as shown in FIG. 8 and FIG. 9, by applying the conductive V frit 22 to side surfaces of the spacers 12 by coating, it is also possible to impart a getter action to the spacer 12. In this case, since conductive V frit 22 is applied to the side surfaces of the spacers 12 by coating, a base body of the spacer 12 may be formed of an insulating object.

A sealing material 5 which seals the face substrate 2 and the back substrate 1 is made of insulating V frit in the same manner as the embodiment 1. V frit may be also applied to an inner surface of the support body 3 by coating. To use conductive V frit 22 as V frit, it is necessary to supply a fixed potential to conductive V frit 22. However, it is difficult to supply the fixed potential to such a portion in terms of structure. Accordingly, insulating V frit 21 may be applied to the inside of the support body 3 by coating. The support body 3 is originally insulating and hence, the property of the support body 3 is not particularly changed even when insulating V frit 21 is formed on the side surface of the support body 3.

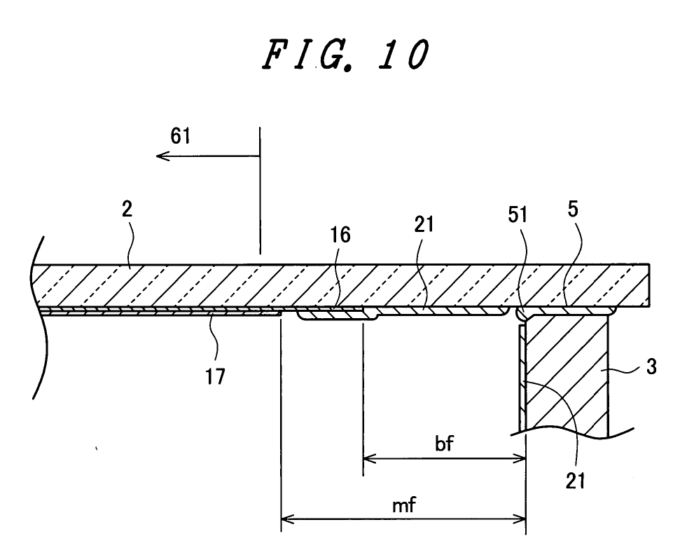

V frit may be also applied to the inside of the face substrate 2 by coating. FIG. 10 shows a region to which V frit is applied outside an effective screen 61 of the face substrate 2 by coating. In FIG. 10, a region of a BM 16 extends outermost, and a distance bf between an end portion of the BM 16 and the support body 3 is approximately 10 mm. Further, a distance mf between an end portion of a metal back 17 and the support body 3 is approximately 15 mm. Such a region is formed around the whole periphery of the effective screen 61. A high voltage of 8 kV to 10 kV is applied to the BM 16 and hence, the use of conductive V frit 22 around the BM 16 is dangerous from a viewpoint of voltage resistance. Accordingly, insulating V frit 21 is used to form a peripheral portion of the BM 16. Here, V frit for such a portion is most preferably of a high resistance material having resistance of 10⁹ Ω-cm or more. With the use of such a high resistance material, it is possible to prevent a spark by gradually lowering a high voltage.

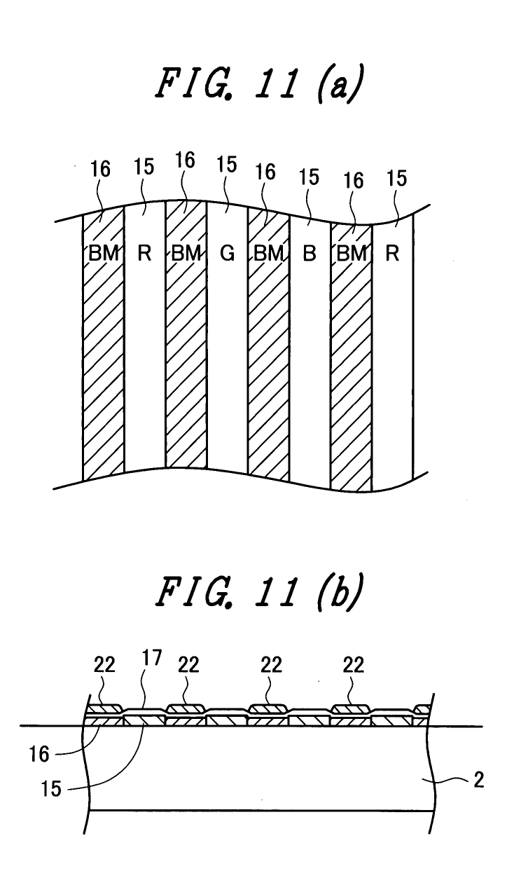

FIG. 11A and FIG. 11B are schematic views of a phosphor screen within an effective surface of the face substrate 2. FIG. 11A is a schematic plan view of the phosphor screen in a state that the metal back 17 is removed therefrom. In this example, the phosphors 15 are formed in a stripe shape. The BM 16 is formed between the phosphors 15 to enhance contrast. The red, green and blue phosphors 15 are sequentially formed with the BM 16 sandwiched therebetween. A pitch of the phosphors 15 or BM 16 is 200 μm, and a width of the BM 16 is 100 μm. FIG. 11B shows the cross-sectional structure of the phosphor screen of this embodiment. The phosphor 15 is formed between the BM 16, and the metal back 17 is formed to cover the BM 16 and the phosphors 15. Further, over the metal back 17, V frit is formed on the BM films 16. To prevent V frit from being charged with electricity in such a case, V frit is preferably a conductive V frit 22. Although a width of V frit is as narrow as 100 μm, V frit may be formed by a printing method. By applying V frit to the BM 16 by coating, an approximately half of the effective screen 61 can be covered with V frit and hence, it is possible to acquire a large area as a getter action region in total.

As described above, by selectively using insulating V frit and conductive V frit in the embodiment 2, the coating area of V frit can be increased thus acquiring an excellent getter effect.

### Embodiment 3

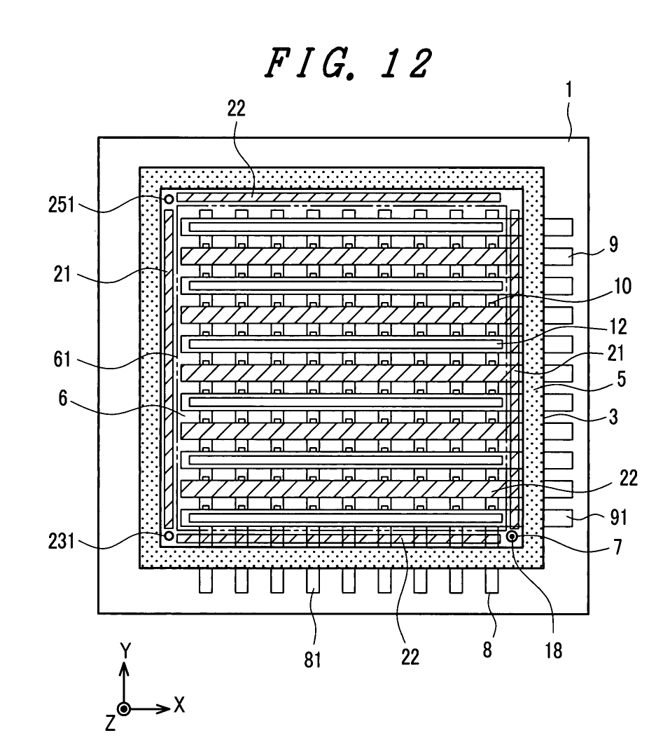

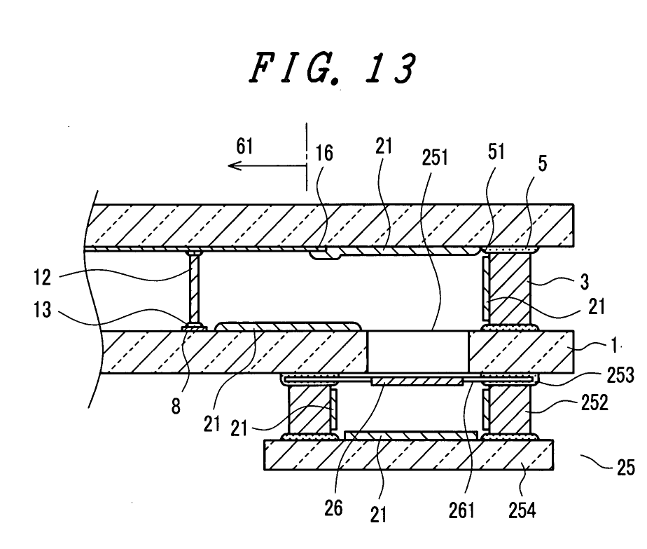

An embodiment 3 describes an example in which a non-volatile zirconium (Zr) getter is used for further increasing the getter effect compared to the embodiment 2. In the embodiment 3, the Zr getter is arranged or positioned on a left upper portion of a display region 6 of a back substrate 1 shown in FIG. 12. A Zr getter chamber through hole 251 is formed in a left upper portion of the display region 6 of the back substrate 1 in FIG. 12.

FIG. 13 is a schematic cross-sectional view of a Zr getter chamber 25. A cover 254 is mounted on a back substrate 1 using a Zr getter chamber support body 252 by way of a sealing material 253. A Zr getter holder 261 which holds a Zr getter 26 is simultaneously mounted on the back substrate 1 by the sealing material 253 at the time of mounting the Zr getter chamber support body 252. After performing the vacuume vacuation of the display device and performing chipping-off of an exhaust pipe, the Zr getter 26 is subjected to high-frequency heating to activate.

Since the Zr getter 26 is non-volatile, V frit is also applied to the inside of the Zr getter chamber by coating. As there is no voltage supply means provided, insulating V frit 21 is used. Further, the Zr getter chamber sealing material 253 is also made of insulating V frit 21. Further, the constitutions of the face substrate 2 and the back substrate 1 are substantially equal to the corresponding constitutions of the embodiment 2.

In this embodiment, the relatively large Zr getter 26 is used and hence, the Zr getter chamber is formed. However, when a small Zr getter is used, it is unnecessary to separately form the Zr getter chamber, and the Zr getter 26 may be arranged outside an effective screen 61 of a display region 6. In this case, the holder 261 of the Zr getter 26 may be simultaneously sealed along with sealing of the back substrate 1 and the support body 3.

According to this embodiment, in addition to the getter effect acquired by V frit, the getter effect by the Zr getter is acquired and hence, it is possible to expect the larger getter effect. By using the Zr getter and V frit in combination, the Ba getter may be omitted.

What is claimed is:

1. A display device in which an envelope which holds a vacuum therein is formed of a face substrate, a back substrate and a support body which is arranged between peripheries of the face substrate and the back substrate, electron sources are arranged on the back substrate in a matrix array, phosphors are arranged on the face substrate at portions of the face substrate corresponding to the electron sources, and an effective screen part is formed of the electron sources arranged in a matrix array and the phosphors, wherein
a sealing material between the face substrate and the support body and between the back substrate and the support body is made of frit glass which contains vanadium oxide as a main component.

2. A display device according to claim 1, wherein the frit glass which forms the sealing material possesses an insulating property.

3. A display device according to claim 1, wherein the frit glass which forms the sealing material contains 30% to 40% of vanadium oxide in V₂O₅ conversion and, at the same time, contains 25% to 35% of tellurium oxide in TeO₂ conversion.

4. A display device in which an envelope which holds a vacuum therein is formed of a face substrate, a back substrate and a support body which is arranged between peripheries of the face substrate and the back substrate, electron sources are arranged on the back substrate in a matrix array, phosphors are arranged on the face substrate at portions of the face substrate corresponding to the electron sources, and an effective screen part is formed of the electron sources arranged in a matrix array and the phosphors, wherein
a peripheral portion is formed between an end portion of the effective screen part and the support body, spacers which hold a distance between the face substrate and the back substrate are arranged within the effective screen part, the spaces are mounted on the face substrate and the back substrate using an adhesive material, and the adhesive material is made of frit glass which contains vanadium oxide as a main component.

5. A display device according to claim 4, wherein the frit glass which contains vanadium oxide as a main component possesses a conductivity.

6. A display device according to claim 4, wherein the frit glass which contains vanadium oxide as a main component contains 50% to 65% of vanadium oxide in V₂O₅ conversion and, at the same time, contains 20% to 30% of phosphorus oxide in P₂O₅ conversion.

7. A display device according to claim 4, wherein the frit glass which contains vanadium oxide as a main component is formed on a side surface of the spacer.

8. A display device in which an envelope which holds a vacuum therein is formed of a face substrate, a back substrate and a support body which is arranged between peripheries of the face substrate and the back substrate, a plurality of video signal lines which extend in a first direction and are arranged in parallel in a second direction, a plurality of scanning lines which extend in the second direction and are arranged in parallel in the first direction, and electron sources which are arranged in the vicinity of intersecting portions of the scanning lines and the video signal lines are formed on the back substrate, phosphors are arranged on the face substrate at portions of the face substrate corresponding to the electron sources, a black matrix is formed around the phosphor, an effective screen part is formed of the electron sources and the phosphors, a peripheral portion is formed between an end portion of the effective screen part and the support body, and spacers which hold a distance between the face substrate and the back substrate are arranged within the effective screen part, wherein
frit glass which contains vanadium oxide as a main component is formed on the scanning lines.

9. A display device in which an envelope which holds a vacuum therein is formed of a face substrate, a back substrate and a support body which is arranged between peripheries of the face substrate and the back substrate, a plurality of video signal lines which extend in a first direction and are arranged in parallel in a second direction, a plurality of scanning lines which extend in the second direction and are arranged in parallel in the first direction, and electron sources which are arranged in the vicinity of intersecting portions of the scanning lines and the video signal lines are formed on the back substrate, phosphors are arranged on the face substrate at portions of the face substrate corresponding to the electron sources, a black matrix is formed around the phosphor, an effective screen part is formed of the electron sources and the phosphors, a peripheral portion is formed between an end portion of the effective screen part and the support body, and spacers which hold a distance between the face substrate and the back substrate are arranged within the effective screen part, wherein
frit glass which contains vanadium oxide as a main component is formed on the peripheral portion of the face substrate.

10. A display device according to claim 9, wherein the frit glass which contains vanadium oxide as a main component and is formed on the peripheral portion of the face substrate has a resistivity equal to or more than 10⁹ Ω·cm.

11. A display device in which an envelope which holds a vacuum therein is formed of a face substrate, a back substrate and a support body which is arranged between peripheries of the face substrate and the back substrate, a plurality of video signal lines which extend in a first direction and are arranged in parallel in a second direction, a plurality of scanning lines which extend in the second direction and are arranged in parallel in the first direction, and electron sources which are arranged in the vicinity of intersecting portions of the scanning lines and the video signal lines are formed on the back substrate, phosphors are arranged on the face substrate at portions of the face substrate corresponding to the electron sources, a black matrix is formed around the phosphor, an effective screen part is formed of the electron sources and the phosphors, a peripheral portion is formed between an end portion of the effective screen part and the support body, and spacers which hold a distance between the face substrate and the back substrate are arranged within the effective screen part, wherein
frit glass which contains vanadium oxide as a main component is formed on the peripheral portion of the back substrate.

12. A display device in which an envelope which holds a vacuum therein is formed of a face substrate, a back substrate and a support body which is arranged between peripheries of the face substrate and the back substrate, a plurality of video signal lines which extend in a first direction and are arranged in parallel in a second direction, a plurality of scanning lines which extend in the second direction and are arranged in parallel in the first direction, and electron sources which are arranged in the vicinity of intersecting portions of the scanning lines and the video signal lines are formed on the back substrate, phosphors are arranged on the face substrate at portions of the face substrate corresponding to the electron sources, a black matrix is formed around the phosphor, an effective screen part is formed of the electron sources and the phosphors, a peripheral portion is formed between an end portion of the effective screen part and the support body, and spacers which hold a distance between the face substrate and the back substrate are arranged within the effective screen part, wherein
frit glass which contains vanadium oxide as a main component is formed on an inner surface of the support body.
